(19) United States
(12) Patent Application Publication
(10) Pub. No.: US 2010/0113081 A1
(43) Pub. Date: May 6, 2010

(54) MOBILE STATION, RADIO ACCESS NETWORK APPARATUS, AND MOBILE COMMUNICATIONS SYSTEM

(75) Inventors: Minami Ishii, Kanagawa (JP); Anil Umesh, Kanagawa (JP); Sadayuki Abeta, Kanagawa (JP)

Correspondence Address: OSHA LIANG L.L.P., TWO HOUSTON CENTER, 909 FANNIN, SUITE 3500, HOUSTON, TX, 77010, US

(73) Assignee: NTT DOCOMO, INC., Tokyo (JP)

(21) Appl. No.: 12/525,557

(22) PCT Filed: Feb. 6, 2008
(86) PCT No.: PCT/JP2008/051959

§ 371 Date: Sep. 10, 2009

(30) Foreign Application Priority Data
Feb. 7, 2007 (JP) 2007-028627
Jun. 25, 2007 (JP) 2007-167008

(51) Int. Cl. H04B 7/00

(52) U.S. Cl. 455/509

(57) ABSTRACT

A radio access network apparatus is disclosed. The apparatus communicates with a mobile station using a dedicated uplink channel, a downlink shared data channel, and a downlink signaling control channel. The apparatus includes a dedicated uplink channel allocating unit which allocates, to a mobile station starting or restarting communications, on a downlink shared data channel, a dedicated uplink channel to be used by the mobile station; a dedicated channel reception detecting unit which detects, on the allocated dedicated uplink channel, a reception of an uplink transmission from the mobile station; and a downlink transmitting unit which, when the dedicated channel reception of the mobile station is detected, transmits a response to the mobile station using the downlink shared data channel and the downlink signaling control channel.

### BACKGROUND OF THE INVENTION

1. Field of the Invention

The present invention relates to mobile stations, radio access network apparatuses, and mobile communications systems.

2. Description of the Related Art

As illustrated in FIG. 1, a mobile station UE transmits a Random access preamble to a radio access network apparatus eNB to request for starting a communication when the mobile station starts or restarts a communication with the radio access network apparatus in Long Term Evolution (LTE), which is being considered for 3G systems. Before multiple mobile stations can simultaneously transmit the Random access preambles, the radio access network apparatus reports, to the respective mobile stations, multiple Signatures available for the respective mobile stations. The mobile station randomly selects a Signature from the multiple Signatures reported in advance, and transmits the Random access preamble using the selected Signature. The radio access network apparatus which has detected one or more Signatures returns, on a shared data channel, one or more Random access responses to the detected one or more Signatures.

The radio access network apparatus which has received the Random access preamble cannot identify whether the mobile station is starting a new communication, making a new connection to a cell for handover to, or restarting a communication. Therefore, the following three types of communication setup information are newly assigned on a uniform basis to the respective Signatures received.

Uplink allocation resource (UL grant)

Uplink timing information (UL timing advance)

Cell-specific user-specific identifier (C-RNTI: Cell specific radio network temporal identifier)

The mobile station which has transmitted the Random access preamble receives the Random access response from the radio access network apparatus, and receives the UL grant, UL timing advance, and C-RNTI that are allocated to the Signature transmitted by the mobile station.

### SUMMARY OF THE INVENTION

### Problem(s) to be Solved by the Invention

In this way, when a communication is started using the Random access preamble, multiple mobile stations may select and use the same Signature, in which case, collision occurs among the Signatures and the multiple mobile stations end up using the same resource for transmitting. Thus, there is a problem that, in a radio access network apparatus, Scheduled Transmissions ((3) in FIG. 1) are simultaneously transmitted from the multiple mobile stations using the same uplink radio resource, so that a correct uplink signal cannot be received.

Moreover, in a Random access response in the LTE, the UL grant, Timing advance, and C-RNTI sent to the respective Signatures need to be returned in a uniform manner regardless of the state of the mobile station. Thus, even unnecessary information may be allocated for the mobile station which already has the C-RNTI of the cell for handover to, or a mobile station which already has the C-RNTI for restarting data transmission, so that downlink radio resources may be wasted.

### Means for Solving the Problem

In order to solve the above problem, a radio access network apparatus is provided, which communicates with a mobile station using a dedicated uplink channel, a downlink shared data channel, and a downlink signaling control channel. The apparatus includes:

a dedicated uplink channel allocating unit which allocates, to a mobile station starting or restarting communications, on a downlink shared data channel, a dedicated uplink channel to be used by the mobile station;

a dedicated uplink channel reception detecting unit which detects, on the allocated dedicated uplink channel, a reception of an uplink transmission from the mobile station; and

a downlink transmitting unit which, when the dedicated uplink channel reception of the mobile station is detected, transmits a response, to the mobile station, using a downlink shared data channel and a downlink signaling control channel.

The radio access network apparatus makes it possible to efficiently utilize downlink radio resources.

Moreover, the mobile station is provided, which communicates with a radio access network apparatus using a dedicated uplink channel, a downlink shared data channel, and a downlink signaling control channel. The mobile station includes,

a dedicated uplink channel allocating information receiving unit which receives, on a downlink shared data channel, allocation information on a dedicated uplink channel to be used;

a dedicated uplink channel setting unit which sets the allocated dedicated uplink channel;

an uplink transmit unit for transmitting uplink on the set dedicated uplink channel; and

a data receive unit which receives downlink with a user-specific identifier after the end of the uplink transmission.

The mobile station makes it possible to efficiently utilize downlink radio resources.

Furthermore, a mobile communications system is provided, which communicates with a mobile station and a radio access network apparatus using a dedicated uplink channel, a downlink shared data channel, and a downlink signaling control channel. In the mobile communications system, the radio access network apparatus includes

a dedicated uplink channel allocating unit which allocates, to a mobile station starting or restarting communications, on the downlink shared data channel, a dedicated uplink channel to be used by the mobile station;

a dedicated uplink channel reception detecting unit which detects, on the allocated dedicated uplink channel, a reception of an uplink transmission from the mobile station; and

a downlink transmitting unit which, when the dedicated uplink channel reception of the mobile station is detected, transmits a response, to the mobile station, using a downlink shared data channel and a downlink signaling control channel,

and wherein the mobile station includes

a dedicated uplink channel allocating information receiving unit which receives on a downlink shared data channel allocation information to be used on a dedicated uplink channel;

a dedicated uplink channel setting unit which sets the allocated dedicated uplink channel; and

an uplink transmit unit which transmits uplink on the set dedicated uplink channel; and

a data receive unit which receives downlink with a user-specific identifier after the end of the uplink transmission.

The mobile communications system makes it possible to efficiently utilize downlink radio resources.

### ADVANTAGE OF THE INVENTION

According to the embodiment of the present invention, eliminating unnecessary transmissions of UL grant, UL timing advance, or C-RNTI (Cell specific radio network temporal identifier) makes it possible to implement a mobile station, a radio access network apparatus, and a mobile communications system that allow an efficient use of downlink radio resources.

### BRIEF DESCRIPTION OF THE DRAWINGS

FIG. 1 illustrates a sequence chart showing a sequence of starting and restarting a communication of a mobile station;

FIG. 2 is an overview diagram of a mobile communications system which includes a radio access network apparatus and a mobile station;

FIG. 3 is a functional block diagram of a mobile station according to an embodiment of the present invention; and

FIG. 4 is a functional block diagram of a radio access network apparatus according to an embodiment of the present invention.

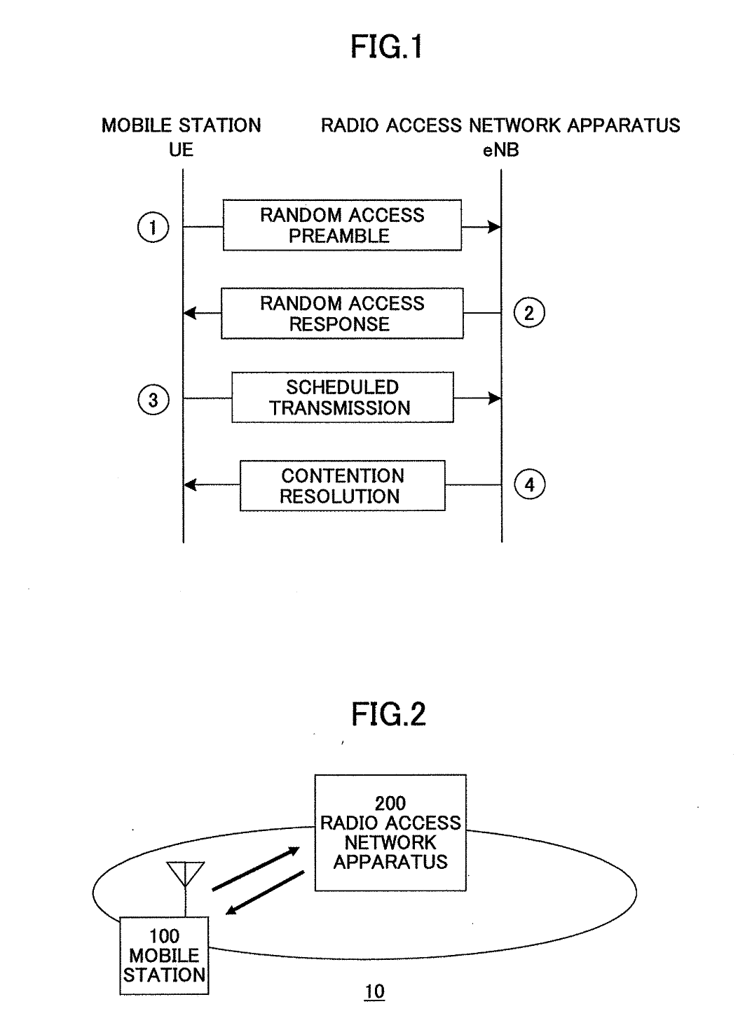

### DESCRIPTION OF THE PREFERRED EMBODIMENTS

### Description of Notations

100 mobile station
102 data transmitter/receiver
104 dedicated uplink channel allocation information receiver
106 dedicated uplink channel setting unit
108 transmit signal generator
200 radio access network apparatus
202 data transmitter/receiver
204 downlink shared data channel/downlink signaling control channel generator
206 dedicated uplink channel selector
208 communications start and restart determining unit
210 dedicated uplink channel detector
212 mobile station specifying unit

### BEST MODE OF CARRYING OUT THE INVENTION

In the following, best modes for carrying out the invention are described based on the following embodiments with reference to the drawings. Throughout the drawings for explaining the embodiments, the same letters are used for those elements having the same functions, so that repetitive explanations are omitted.

In LTE, a radio access network apparatus, when transmitting a handover request signal to a mobile station, allocates to the mobile station, together with the handover request signal, a user-specific Signature used at the time the mobile station connects to a cell for handover to in order to avoid a Signature collision. The mobile station which has received the handover request signal uses the allocated user-specific Signature to transmit a Random access preamble to the cell for handover to. Now an embodiment of the present invention is considered with respect to a sequence in which the radio access network apparatus which has detected the Random access preamble returns a Random Access Response.

A mobile communications system according to an embodiment of the present invention is described with reference to FIG. 2.

A mobile communications system 10 includes a mobile station 100 and a radio access network apparatus 200.

The mobile station 100 and the radio access network apparatus 200 communicate using a dedicated uplink channel, a downlink shared data channel, and a downlink signaling control channel.

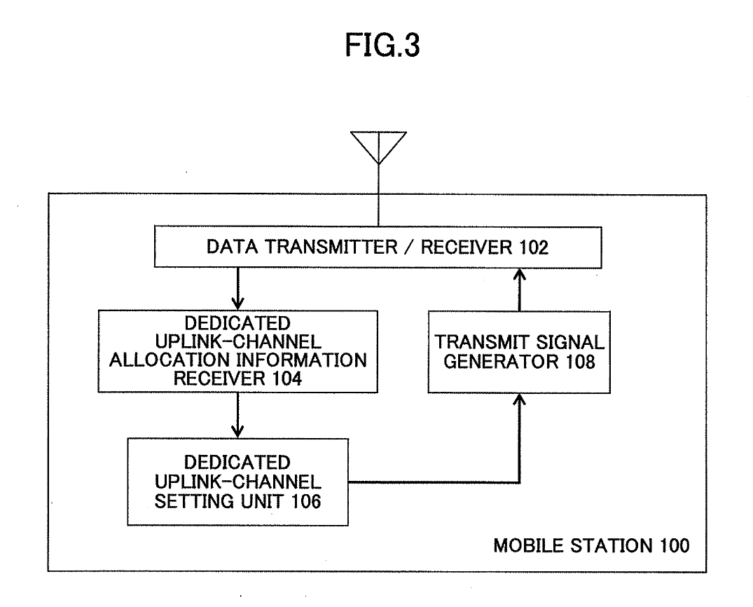

Now a mobile station 100 according to an embodiment of the present invention is described with reference to FIG. 3.

The mobile station 100 includes a data transmitter/receiver 102 with an antenna; a dedicated uplink channel allocation information receiver 104, which is connected to the data transmitter/receiver 102; a dedicated uplink channel setting unit 106, which is connected to the dedicated uplink channel allocation information receiver 104; and a transmit signal generator 108, which is connected to the dedicated uplink channel setting unit 106 and the data transmitter/receiver 102.

The data transmitter/receiver 102 transmits and receives data. For example, the mobile station 100 may determine whether the downlink signaling control channel is destined for the mobile station itself based on the C-RNTI received on the downlink signaling control channel. Moreover, information of a radio resource of a downlink data channel destined for the mobile station may be received from the downlink shared radio resource information transmitted on the downlink signaling control channel.

The dedicated uplink channel allocation information receiver 104 receives a dedicated uplink channel allocation information signal indicating dedicated uplink channel allocation information for the mobile station. For example, the dedicated uplink channel allocation information signal is transmitted on the downlink shared data channel as a part of a signal requesting for restarting downlink transmission or a handover request signal. Moreover, the dedicated uplink channel allocation information is communications setting information for setting any one of a mobile station-specific Signature used on the Access preamble, an identifier or a code number that is used for uplink, and an uplink radio resource.

When a shortage occurs with respect to the dedicated uplink channel provided in advance at the radio access network apparatus, that the Random access preamble signal is to be used may be reported to the mobile station in the downlink shared data channel.

The dedicated uplink channel setting unit 106 sets a dedicated uplink channel according to dedicated uplink allocation information received at the uplink shared channel allocation information receiver 104.

The transmit signal generator 108 generates a signal to be transmitted on the dedicated uplink channel which is set at the dedicated uplink channel setting unit 106, and transmits the generated signal to the data transmitter and receiver 102. The data transmitter and receiver 102 of the mobile station 100 wirelessly transmit the generated signal to the radio access network apparatus. In this way, the mobile station transmits, to the radio access network apparatus, an access preamble, for example.

The mobile station 100 which has transmitted the generated signal from the data transmitter/receiver 102 receives a downlink signaling control channel and a downlink shared data channel based on the C-RNTI.

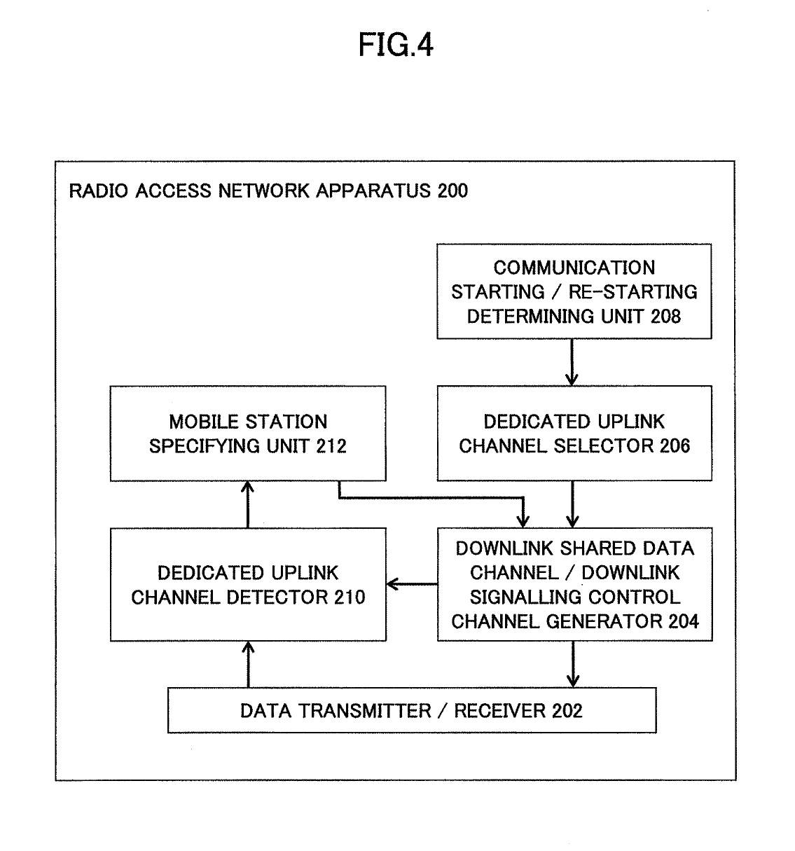

Now a radio access network apparatus 200 according to an embodiment of the present invention is described with reference to FIG. 4. For convenience of explanation, a radio access network apparatus which wirelessly communicates with a mobile station is explained. However, more generally, the radio access network apparatus may communicate not only with a mobile station, but also user equipment (UE) including a fixed station.

The radio access network apparatus 200 includes a data transmitter/receiver 202; a downlink shared data channel/downlink signaling control channel generator 204, which is connected to the data transmitter/receiver 202; a dedicated uplink channel selector 206, which is connected to the downlink shared data channel/downlink signaling control channel generator 204; and a communication start/restart determining unit 208, which is connected to the dedicated uplink channel selector 206. Moreover, the radio access network apparatus 200 includes a dedicated uplink channel detector 210, which is connected to the downlink shared data channel/downlink signaling control channel generator 204; and a mobile station specifying unit 212, which is connected to the dedicated uplink channel detector 210.

The communication start/restart determining unit 208 determines whether a mobile station to be managed by the radio access network apparatus starts or restarts communications. The communications start means that the mobile station being instructed to conduct a handover starts communications with the radio access network apparatus for handover to, for example. Moreover, the communications restart means a communications restart when downlink data to the mobile station performing intermittent reception is produced, for example.

For a mobile station which needs communications start or restart, the dedicated uplink channel selector 206 selects dedicated uplink channel allocation information to be used by the mobile station. The dedicated uplink channel allocation information is any one of an uplink radio resource, an uplink identifier or code number, and Signature of an Access preamble, for example.

If a shortage occurs with respect to the dedicated uplink channel provided in advance at the radio access network apparatus, that the Random access preamble signal is to be used for uplink may be reported to the mobile station in the downlink shared data channel.

The downlink shared data channel/downlink signaling control channel generator 204 generates a dedicated uplink channel allocation information signal indicating the dedicated uplink channel allocation selected at the dedicated uplink channel selector 206. For example, the dedicated uplink channel allocation information signal is transmitted on the downlink shared data channel as apart of a signal requesting for restarting downlink data transmission or a handover request signal.

The dedicated uplink channel detector 210 receives the dedicated uplink channel allocation transmitted as a part of the signal generated at the downlink shared data channel/downlink signaling control channel generator 204, and detects the presence/absence of uplink transmission in the dedicated uplink channel. The dedicated uplink channel is detected through a value of correlation with a Signature of access preamble allocated as dedicated uplink channel allocation information, for example.

The mobile station specifying unit 212 specifies the mobile station with the dedicated uplink channel detected at the dedicated uplink channel detector 210. For example, when a mobile station-specific Signature used on an access preamble is allocated as an uplink shared channel, the mobile station is specified using the Signature. Moreover, when a mobile station specific code is allocated as dedicated uplink channel allocation information, the mobile station is specified based on the outcome of identifying the mobile station-specific code.

The mobile station specifying unit 212 transmits the mobile station-specific result to the downlink shared data channel/downlink signaling control channel generator 204. The downlink shared data channel/downlink signaling control channel generator 204 determines whether transmission, to the specified mobile station, is required of two types of communications setting information (UL grant, UL timing advance), or only the UL timing advance, and transmits required information in the downlink shared data channel/downlink signaling control channel using a mobile station-specific identifier (C-RNTI). For example, the radio access network apparatus 200 determines that the two types of communications settings are required at the time of handover, and determines that the UL timing advance only is required at the time of restarting downlink data transmission.

According to the embodiment of the present invention, eliminating unnecessary transmissions of UL grant, UL timing advance, or C-RNTI (Cell specific radio network temporal identifier) makes it possible to implement a mobile station, a radio access network apparatus, and a mobile communications system that allow an efficient use of downlink radio resources.

As described above, in order to reduce the probability of multiple mobile stations selecting the same Signature and thereby, causing collision, a dedicated signature provided in advance is allocated, for a certain period, to a mobile station already having C-RNTI. Typical examples of such a mobile station are: (1) a mobile station to which is allocated, at the time of handover, a dedicated signature and C-RNTI of a cell for handover to as a part of a handover command from a cell for handover from; and (2) a mobile station already having C-RNTI and to which mobile station is allocated, at the time of restarting downlink data transmission, a dedicated preamble used at the time of establishing uplink synchronization.

However, with such a method of decreasing the collision probability, if all of the dedicated channels or dedicated preambles are in use, it is necessary to wait for a dedicated preamble allocation until the dedicated preamble becomes available, causing a delay in the transmit timing of the handover command, and a delay in the restart of the downlink data transmission.

Then, if all the Dedicated preambles are being used (or if there is a shortage), a base station eNB instructs the mobile station UE to transmit a Random access preamble using one Signature randomly selected. More specifically, (1) as a part of a signal transmitted to the mobile station by the base station, some indicator (this may be called a Random access preamble transmission indicator, for example) indicating that the Random access preamble is to be transmitted or (2) a special Dedicated signature representing that a random access preamble is to be used in such a condition may be specified. For example, the Random access preamble transmit identifier (in (1)) may be expressed as a flag bit such as ON or OFF, or the Dedicated signature number may be set to zero (in other words, “0” is specified so that it corresponds to “Random access preamble”.)

In this way, even if all dedicated preambles are being used, a mobile station can rapidly establish uplink synchronization and start or restart communications without delaying handover command transmission and downlink data transmission.

On the other hand, the mobile station which has received (1) a Random access preamble transmission indicator, or (2) a Dedicated signature number indicating that a Random access preamble is to be transmitted randomly selects one Signature out of Signatures transmittable as the Random access preamble according to an instruction from the base station.

As described above, while the present invention is described with reference to specific embodiments, the respective embodiments are merely exemplary, so that a skilled person will understand variations, modifications, alternatives, and replacements. While specific numerical value examples are used to facilitate understanding of the present invention, such numerical values are merely examples, so that any appropriate value may be used unless specified otherwise. For convenience of explanation, while the apparatus according to the embodiments of the present invention is explained using functional block diagrams, such an apparatus as described above may be implemented in hardware, software, or a combination thereof. The present invention is not limited to the above embodiments, so that variations, modifications, alternatives, and replacements are included in the present invention without departing from the spirit of the present invention.

The mobile station, radio access network apparatus, and mobile communications system according to the present embodiments may be applied to mobile communications systems.

As described above, while the present invention is described with reference to specific embodiments, the respective embodiments are merely exemplary, so that a skilled person will understand variations, modifications, alternatives, and replacements. While specific numerical value examples are used to facilitate understanding of the present invention, such numerical values are merely examples, so that any appropriate value may be used unless specified otherwise. Breakdown of the respective embodiments is not essential to the present invention, so that two or more embodiments may be used as needed. For convenience of explanation, while the apparatus according to the embodiments of the present invention is explained using functional block diagrams, such an apparatus as described above may be implemented in hardware, software, or a combination thereof. The present invention is not limited to the above embodiments, so that variations, modifications, alternatives, and replacements are included in the present invention without departing from the spirit of the present invention.

The present international application claims priority based on Japanese Patent Application No. 2007-28627, filed on Feb. 7, 2007, the entire contents of which are hereby incorporated by reference.

The present international application also claims priority based on Japanese Patent Application No. 2007-167008, filed on Jun. 25, 2007, the entire contents of which are hereby incorporated by reference.

1. A radio access network apparatus which communicates with a mobile station using a dedicated uplink channel, a downlink shared data channel, and a downlink signaling control channel, comprising:
a dedicated uplink channel allocating unit which allocates, to a mobile station starting or restarting communications, on the downlink shared data channel, the dedicated uplink channel to be used by the mobile station;
a dedicated uplink channel reception detecting unit which detects, on the allocated dedicated uplink channel, a reception of an uplink transmission from the mobile station; and
a downlink transmitting unit which, when the dedicated uplink channel reception of the mobile station is detected, transmits a response to the mobile station using the downlink shared data channel and the downlink signaling control channel.

2. The radio access network apparatus as claimed in claim 1, wherein
the dedicated uplink channel allocating unit allocates an identifier to be used by the mobile station.

3. The radio access network apparatus as claimed in claim 1,
wherein the dedicated uplink channel allocating unit allocates a Signature to be used by the mobile station for access preamble transmission.

4. The radio access network apparatus as claimed in claim 3, further comprising:
a mobile station specifying unit which specifies the mobile station based on the allocated Signature, wherein
based on the specifying of the mobile station, the dedicated uplink channel allocating unit does not transmit communications setting information unnecessary at the time of responding to the mobile station.

5. The radio access network apparatus as claimed in claim 1, wherein
if a shortage of the dedicated uplink channel provided in advance occurs, that a contention channel signal is to be used for uplink is reported to the mobile station.

6. The radio access network apparatus as claimed in claim 5, wherein
whether the contention channel signal is to be used for the uplink is expressed in a flag bit in a downlink signal.

7. The radio access network apparatus as claimed in claim 5, wherein
if the contention channel signal is to be used in the uplink, the Signature is to be designated.

8. A mobile station which communicates with a radio access network apparatus using a dedicated uplink channel, a downlink shared data channel, and a downlink signaling control channel, comprising
a dedicated uplink channel allocating information receiving unit which receives, on the downlink shared data channel, allocation information on the dedicated uplink channel to be used;
a dedicated uplink channel setting unit which sets the allocated dedicated uplink channel;
an uplink transmit unit for transmitting uplink on the set dedicated uplink channel; and
a data receive unit which receives downlink with a user-specific identifier after the end of the uplink transmission.

9. The mobile station as claimed in claim 8, wherein
at the dedicated uplink channel allocation information receiving unit, a Signature to be used by the mobile station is received.

10. The mobile station as claimed in claim 8, wherein
at the dedicated uplink channel allocation information receiving unit, a Signature of an access preamble to be used by the mobile station is received.

11. The mobile station as claimed in claim 8, wherein
if a shortage of the dedicated uplink channel provided in advance occurs, that a contention channel signal is to be used for uplink is reported from the radio access network apparatus.

12. The mobile station as claimed in claim 11, wherein
a flag bit in a downlink signal is used to determine whether the contention channel signal is to be used in the uplink.

13. The mobile station as claimed in claim 11, wherein
whether a specific signature is designated is used to determine whether the contention channel signal is to be used in the uplink.

14. A mobile communications system which communicates with a mobile station and a radio access network apparatus using a dedicated uplink channel, a downlink shared data channel, and a downlink signaling control channel,
wherein the radio access network apparatus includes
a dedicated uplink channel allocating unit which allocates, to a mobile station starting or restarting communications, on the downlink shared data channel, the dedicated uplink channel to be used by the mobile station;
a dedicated uplink channel reception detecting unit which detects, on the allocated dedicated uplink channel, a reception of an uplink transmission from the mobile station; and
a downlink transmitting unit which, when the dedicated uplink channel reception of the mobile station is detected, transmits a response to the mobile station using the downlink shared data channel and the downlink signaling control channel,
and wherein the mobile station includes
a dedicated uplink channel allocating information receiving unit which receives on the downlink shared data channel, allocation information to be used on the dedicated uplink channel;
a dedicated uplink channel setting unit which sets the allocated dedicated uplink channel; and
an uplink transmit unit which transmits uplink on the set dedicated uplink channel; and
a data receive unit which receives downlink with a user-specific identifier after the end of the uplink transmission.

15. The radio access network apparatus as claimed in claim 2,
wherein the dedicated uplink channel allocating unit allocates a Signature to be used by the mobile station for access preamble transmission.

16. The radio access network apparatus as claimed in claim 2, wherein
if a shortage of the dedicated uplink channel provided in advance occurs, that a contention channel signal is to be used for uplink is reported to the mobile station.

17. The radio access network apparatus as claimed in claim 3, wherein
if a shortage of the dedicated uplink channel provided in advance occurs, that a contention channel signal is to be used for uplink is reported to the mobile station.

18. The radio access network apparatus as claimed in claim 4, wherein
if a shortage of the dedicated uplink channel provided in advance occurs, that a contention channel signal is to be used for uplink is reported to the mobile station.

19. The mobile station as claimed in claim 9, wherein
at the dedicated uplink channel allocation information receiving unit, a Signature of an access preamble to be used by the mobile station is received.

20. The mobile station as claimed in claim 9, wherein
if a shortage of the dedicated uplink channel provided in advance occurs, that a contention channel signal is to be used for uplink is reported from the radio access network apparatus.

21. The mobile station as claimed in claim 10, wherein
if a shortage of the dedicated uplink channel provided in advance occurs, that a contention channel signal is to be used for uplink is reported from the radio access network apparatus.
